(19) United States
(12) Patent Application Publication
(10) Pub. No.: US 2009/0064190 A1
(43) Pub. Date: Mar. 5, 2009

(54) TECHNIQUES FOR RECEIVING EVENT INFORMATION

(76) Inventors: Mindy Pereira, Mountain View, CA (US); David G. Champlin, San Diego, CA (US); Radha Neelakantan, Sunnyvale, CA (US); Lang S. Chen, Oakland, CA (US); Manisha D. Parekh, Mountain View, CA (US)

Correspondence Address: KACVINSKY LLC;4500 BROOKTREE ROAD, SUITE 102, WEXFORD, PA, 15090, US

(21) Appl. No.: 11/848,602

(22) Filed: Aug. 31, 2007

(51) Int. Cl. G06F 13/00

(52) U.S. Cl. 719/318

(57) ABSTRACT

Techniques involving the reception of information regarding scheduled events are disclosed. For example, an apparatus may include an event management module and a communications interface module. The event management module creates an event object corresponding to an event. The event object may include a desired status information indicator. Based on this indicator, the communications interface module receives the desired status information from a remote device.

### BACKGROUND

Devices (e.g., computing and/or communications devices) provide users with the capability to generate and maintain schedules. For example, calendar applications allow users to schedule appointments. Such appointments may involve a single participant or multiple participants (e.g., users of multiple devices). Also, as an appointment's scheduled time approaches, its participants may receive reminder notifications for the appointment.

Peoples” schedules often depend on the occurrence of events. For instance, an appointment to meet a person at an airport may depend on the person's flight arriving. Similarly, an appointment to attend a baseball game depends on the game not being canceled due to rain.

Moreover, a person's participation in a scheduled event may depend on the person being able to attend the event. For instance, while an event may occur, various factors (such as traffic) may prevent the person from making the event (or arriving at the event on time).

Thus, as an event approaches, it may be desirable to receive information regarding the event.

### BRIEF DESCRIPTION OF THE DRAWINGS

FIGS. 1A and 1B illustrate apparatus embodiments.

FIG. 2 is a diagram of an exemplary operational scenario.

FIG. 3 illustrates an embodiment of a logic flow.

FIGS. 4A, 4B, and 5 are diagrams of exemplary event objects.

FIG. 6 is a view of an exemplary handheld device.

### DETAILED DESCRIPTION

Various embodiments may be generally directed to techniques for obtaining information regarding scheduled events. For instance, an apparatus may include an event management module and a communications interface module. The event management module creates an event object corresponding to an event. The event object may include a desired status information indicator. Based on this indicator, the communications interface module receives the desired status information from a remote device.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include other combinations of elements in alternate arrangements. It is worthy to note that any reference to “one embodiment” or “an embodiment” means that a particular feature, structure, or characteristic described in connection with the embodiment is included in at least one embodiment. The appearances of the phrases “in one embodiment” and “in an embodiment” in various places in the specification are not necessarily all referring to the same embodiment.

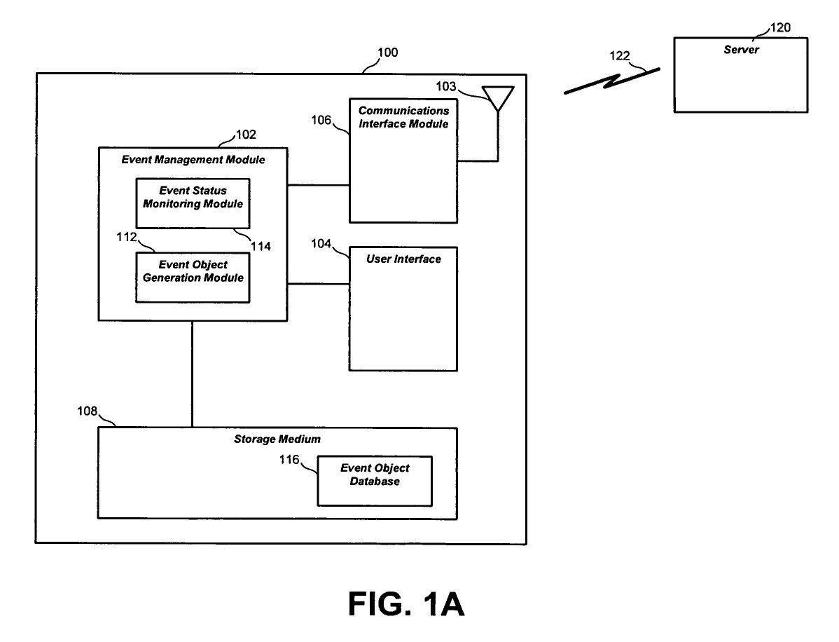

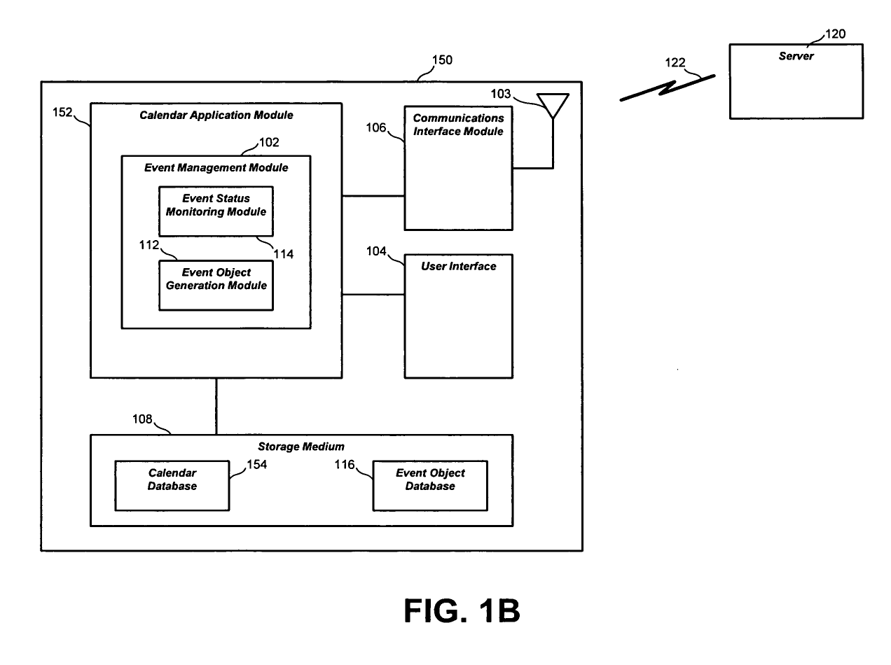

FIG. 1A illustrates an embodiment of an apparatus 100 that may obtain information regarding events. FIG. 1A shows that apparatus 100 may comprise various elements. For instance, FIG. 1A shows that apparatus 100 may include an event management module 102, a user interface 104, a communications interface module 106, and a storage medium 108. The embodiments, however, are not limited to these depicted elements. The elements of apparatus 100 may be implemented in hardware, software, firmware, or any combination thereof.

Event management module 102 may perform operations involving events. For instance, event management module 102 may generate and process event objects. An event object includes information regarding a corresponding event. For example, an event object may include an event time, an event location, an indicator of desired status information, and/or a resource.

An event time within an event object specifies a time of its corresponding event. Likewise an event location of an event object specifies a location of the corresponding event. Such event locations may be in the form of addresses, global positioning system (GPS) coordinates, airport codes, and/or other types of suitable location indicators.

A desired status information indicator within an event object specifies desired information regarding the corresponding event. For example, such indicators may specify scheduling status information (e.g., flight arrival times, train arrival times, etc.), weather reports, and traffic conditions. The embodiments, however, are not limited to these examples. Desired status information indicators may include one or more keywords and/or descriptors that are in accordance with formats and/or conventions that are recognizable by status monitoring elements.

An event object's resource indicates a resource (such as a server) that provides information specified by a desired status information indicator of the event object. For instance, a resource may be in the form of a uniform resource locator (URL). However, resources of other forms or types may be employed.

As shown in FIG. 1A, event management module 102 may include an event object generation module 112 and an event status monitoring module 114.

Event object generation module 112 generates event objects. Such generation may be initiated by a user of apparatus 100. More particularly, a user may perform operations that create an event object. Such operations may include the user commencing an event object generation process, the user entering data associated with the event object, and the user saving the generated event object. Each of these operations may involve the user interacting with user interface 104.

Additionally or alternatively, the generation of event objects may be initiated through messages originated by remote devices. For instance, apparatus 100 may receive a proposed event object message that was originated by a remote device.

Event status monitoring module 114 receives information specified by desired status information indicators of event objects. Such information may be received (via communications interface module 106) from resources specified by the event objects. As described herein, examples of such information may indicate scheduling information regarding the corresponding event, and/or various types of contextual information. Examples of contextual information include traffic conditions and/or weather conditions that are pertinent to the corresponding events. The embodiments, however, are not limited to these examples.

Event status monitoring module 114 may receive such event-related information in various ways. For example, event status monitoring module 114 may generate request messages that request particular information. Such information may be specified by desired status information indicators of event objects. In response, event status monitoring module 114 may receive response messages from the remote devices that include the requested status information.

Alternatively or additionally, status monitoring module 114 may receive information without sending request messages. For instance, event status monitoring module 114 may receive unsolicited status messages. Like the response messages described above, these status messages may provide status information corresponding to the desired status information indicators within the event objects.

In addition, event status monitoring module 114 may upload event objects to remote devices. Such uploading may occur through event object upload messages that include the corresponding event objects. In turn, such remote devices may perform monitoring operations regarding the associated events and report the status of such monitoring operations to event status monitoring module 114. This monitoring and reporting may occur repeatedly (e.g., on a periodic basis). Moreover, such reports may be in the form of the aforementioned status messages.

FIG. 1A shows that communications interface module 106 is coupled to event status monitoring module 114. Communications interface module 106 provides for the exchange of information with other devices. For instance, such information may include messages handled by event status monitoring module 114. Thus, such messages may include the aforementioned request messages, response messages, status messages, and/or event upload messages. The embodiments, however, are not limited to these exemplary messages.

For purposes of illustration, FIG. 1A shows communications interface module 106 (through an antenna 103) exchanging information with a server 120. FIG. 1A further shows that this exchange occurs across a link 122 of a wireless network.

Exemplary wireless networks include wireless local area networks (WLANs), such as IEEE 802.11 WiFi links, as well as wireless metropolitan area networks (WMANs), such as IEEE 802.16 WiMax links and IEEE 802.16e WiBro links. Also, wireless networks may include personal area networks (PAN) such as Bluetooth. Further, wireless networks may include radio frequency identification (RFID) links. Moreover, such wireless networks may include cellular and satellite communications systems. The embodiments, however, are not limited to these examples of wireless networks.

Moreover, communications interface module 106 may (additionally or alternatively) communicate with devices across wired networks. Exemplary wired networks include, for example, local area networks (LANs), such as IEEE 802.3 Ethernet networks, and/or wired telephony networks. The embodiments, however, are not limited to these examples.

To provide such features, communications interface module 106 may include electronics, such as modulators, demodulators, amplifiers, filters, and/or antennas. The embodiments, however, are not limited to these examples. Furthermore, communications interface module 106 may include components and/or functionality to operate according to one or more protocol layers. Such protocol layers may provide features, such as packet encapsulation/decapsulation, error correction encoding/decoding, signaling, link protocols, and/or media access protocols. Embodiments, however, may include other components and/or functionality. These features may be implemented in hardware, software, firmware, or any combination thereof.

User interface 104 facilitates user interaction. This interaction may involve the input of information from a user and/or the output of information to a user. For example, as described herein, user interface 104 may provide for the generation of event objects, the outputting of various event-related notifications, the creation of calendar entries, and so forth. Accordingly, user interface 104 may include one or more devices, such as a keyboard (e.g., a full QWERTY keyboard), a keypad, a display (e.g., a touch screen), a microphone, and/or an audio speaker. The embodiments, however, are not limited to these examples.

As described above, event objects may be saved upon their generation. These saved event objects may be stored in an event object database 116. FIG. 1A shows that event object database 116 may be included in storage medium 110. Event object database 116 may be implemented in various ways (e.g., as a relational database, as an object oriented database, with various data structures/objects, etc.). Thus upon their generation, event object generation module 112 may store event objects in event object database 116.

These stored events may be accessed by event status monitoring module 114 to monitor the corresponding events. As described above, this may involve event status monitoring module 114 (via communications interface module 106) sending request messages to an identified resource. Additionally or alternatively, this may involve event status monitoring module 114 (via communications interface module 106) uploading event objects to remote entities (e.g., servers) for remote monitoring. The embodiments, however, are not limited to this context.

In addition to providing event object database 116, storage medium 110 may store information such application documents, e-mails, media items (e.g., image files, audio files, video files, etc.), and so forth. Such information (as well as the information within event object database 116) may be stored in various encoded or unencoded formats. Storage medium 110 may be implemented using any machine-readable or computer-readable media capable of storing data, including both volatile and non-volatile memory. Examples of such media are provided below.

FIG. 1B shows a further apparatus 150, which is similar to apparatus 100 of FIG. 1A. However, apparatus 150 includes calendar application module 152. Like the elements of FIG. 1A, calendar application module 152 may be implemented with hardware, software, firmware, or any combination thereof.

Calendar application module 152 is also referred to as a personal information management application because it may store and manage personal scheduling information. More particularly, calendar application module 152 may provide a user with the ability to create, view, and manage calendar entries (e.g., appointments). In embodiments, calendar application module 152 may be implemented with or be based on calendar application products currently available from Palm, Inc. of Sunnyvale, Calif. The embodiments, however, are not limited to this context.

FIG. 1B further shows storage medium 110 including a calendar database 154. Calendar database 154 may store various types of information handled by calendar application 120. For example, calendar database 154 may store calendar entries, which may include various data fields. For example, a calendar entry may include an appointment title, start and end times, a duration, one or more participants, a location, user generated text, and so forth.

As shown in FIG. 1B, event management module 102 may be included in calendar application module 152. Thus, in embodiments, calendar entries may also include event objects. This inclusion of event objects may occur during or after the creation of the calendar entry.

Thus, event objects may be stored with calendar entries in calendar database 154. Additionally or alternatively, event objects that are included in calendar entries may be stored in event object database 116. Such stored event objects may provide a reference or link to the corresponding calendar entries in calendar database 154.

In the examples of FIGS. 1A and 1B, event objects and calendar entries may be stored locally (e.g. within storage medium 108). However, embodiments may store event objects remotely. For instance, event objects and/or calendar entries may be uploaded and stored by a remote device. Furthermore, as described herein, the remote device may perform monitoring operations and report the status of such monitoring operations to apparatus 100 and/or apparatus 150.

As described above, monitoring operations performed by status monitoring module 114 (of apparatus 100 and/or apparatus 150) and/or remote entities may involve generating requests in particular formats based on information. This information may include data contained in event objects, such as desired status information indicators. Accordingly, desired status information indicators may be formatted to include keywords and/or descriptors that are recognizable by status monitoring module 114 and/or remote entities.

Additionally, requests may be generated based on further information. This information may include other data in the event objects, such as event time information, event location information, and so forth. Moreover, this information may include data not contained in event objects, such a predetermined location (e.g., work, home, current location, etc.) of apparatus 100. Thus, although not shown, apparatus 100 and/or apparatus 150 may each include a position determining module (such as a global positioning system receiver) that determines a current location of apparatus 100.

As described above, the elements of FIG. 1A and 1B may be implemented in hardware, software, firmware, or any combination thereof. Thus, implementations may include one or more processors that execute instructions or control logic stored in a storage medium (e.g., memory) such as storage medium 108. The embodiments, however, are not limited to such implementations.

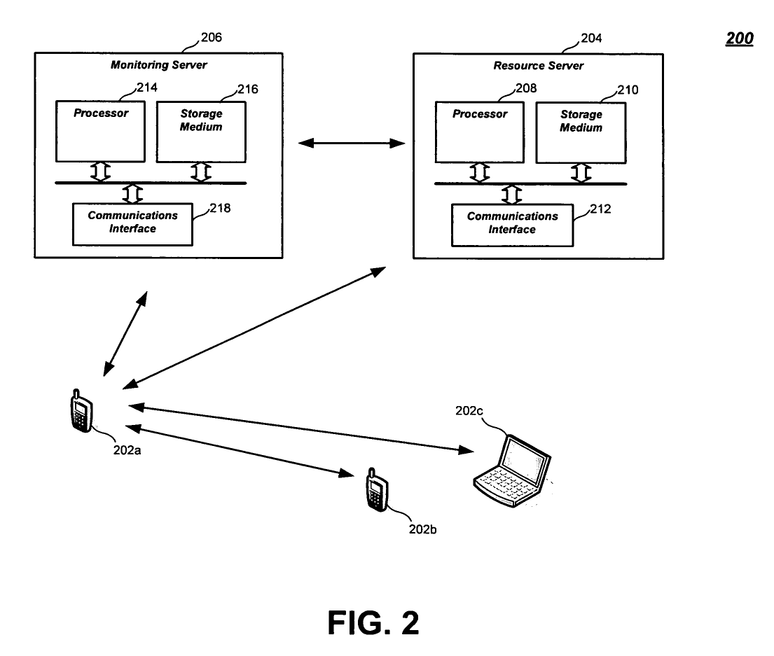

FIG. 2 is a diagram of an exemplary operational environment 200. This environment includes multiple user devices 202a-c, a resource server 204, and a monitoring server 206. These elements may exchange information regarding event objects. Although not shown, the exchange of information among these devices may occur across one more wired or wireless communications networks.

Each of user devices 202a-c may be implemented to include apparatus 100 of FIG. 1A or apparatus 150 of FIG. 1B. The embodiments, however, are not limited to such implementations. In the scenario of FIG. 2, user device 202a has created one or more event objects. These event objects may be included in calendar entries (e.g., appointments) that also list the users of devices 202b and 202c as participants.

Resource server 204 may provide information specified by desired status information indicators of event objects. Such information may include, for example, weather conditions, traffic conditions, transportation event data (e.g., flight arrival times, etc.). The embodiments, however, are not limited to these examples.

Accordingly, user device 202a may obtain such status information from resource server 206. This may occur through user device 202a sending request messages to resource server 204, and resource server 204 sending corresponding response messages to user device 202a.

Additionally or alternatively, such information may be provided to user device 202a through monitoring server 206. For instance, user device 202a may upload an event object to monitoring server 206. In turn, monitoring server 206 may send request message(s) to resource server 204. In response, resource server 204 may send response messages to monitoring server 206 that provide the requested information. In turn, monitoring server 206 may send such information to user device 202a. As an alternative, resource server 204 may send the information to user device 202a instead of to monitoring server 206.

As described above, user device 202a may create event objects that are included in calendar entries. Such calendar entries may include the users of user devices 202b and 202c. Thus, when user device 202a receives information from resource server 204 or monitoring server 206, its user may be prompted to modify a corresponding calendar entry. If the user desires to modify the appointment, user device 202a may engage in communications with user devices 202b and 202c for their acceptance or rejection of this modification.

FIG. 2 shows that resource server 204 may include a processor 208, a storage medium 210, and a communications interface 212. Similarly, FIG. 2 shows that monitoring server 206 may include a processor 214, a storage medium 216, and a communications interface 218.

Processors 208 and 214 may each include one or more processing elements (e.g., one or more microprocessors). Thus, processors 208 and 214 may execute control logic or instructions (e.g., software) that may provide functionality for the features of servers 204 and 206. Storage media 210 and 216 may each store such control logic or instructions.

In addition, storage media 210 and 216 may each store data. For instance, storage medium 210 of resource server 204 may store information specified by event object tracking items. Also, storage medium 216 may store event objects uploaded by user devices (such as user device 202a). However, storage media 210 and 216 may store other forms of data.

Storage media 210 and 216 may each be implemented using any machine-readable or computer-readable media capable of storing data, including both volatile and non-volatile memory. Examples of such media are provided below.

Communications interfaces 212 and 218 may each provide for the exchange of information with other devices, as described herein. Accordingly, these communications interfaces may each include components to communicate across various network(s), such as the wired or wireless networks described above with reference to FIGS. 1A and 1B. To provide such features, communications interfaces 212 and 218 may each include electronics, such as modulators, demodulators, amplifiers, filters, and/or antennas. The embodiments, however, are not limited to these examples.

Moreover, communications interfaces 212 and 218 may each include components and/or functionality to operate according to one or more protocol layers. Such protocol layers may provide features, such as packet encapsulation/decapsulation, error correction encoding/decoding, signaling, link protocols, and/or media access protocols. Embodiments, however, may include other components and/or functionality. These features may be implemented in hardware, software, firmware, or any combination thereof.

Embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented, unless otherwise indicated. In addition, the given logic flow may be implemented by a hardware element, a software element executed by a processor, or any combination thereof. The embodiments are not limited in this context.

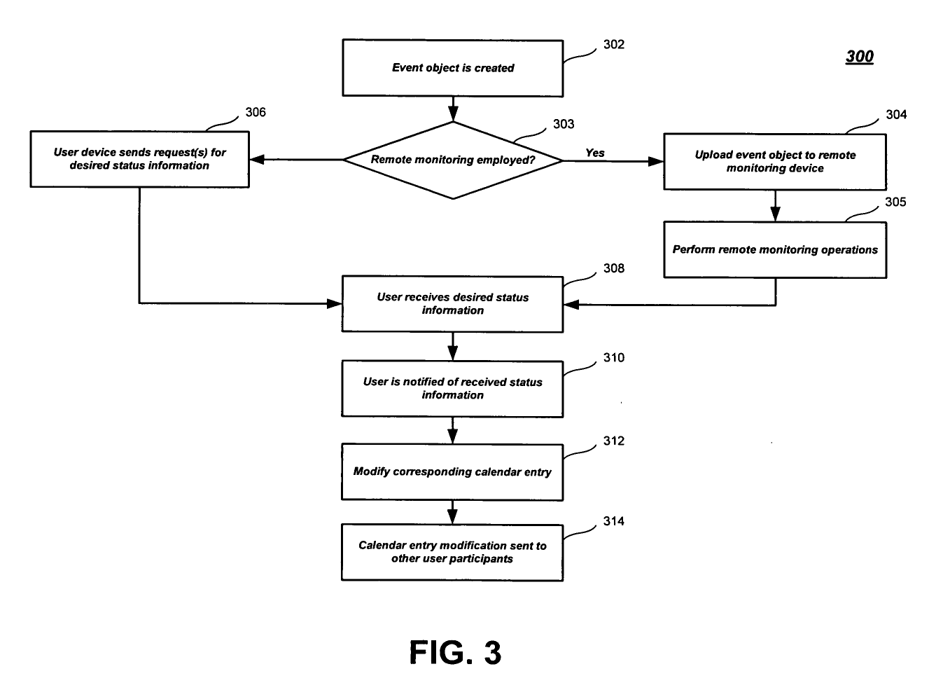

FIG. 3 illustrates one embodiment of a logic flow. In particular, FIG. 3 illustrates a logic flow 300, which may be representative of the operations executed by one or more embodiments described herein. Although FIG. 3 shows a particular sequence, other sequences may be employed. Also, the depicted operations may be performed in various parallel and/or sequential combinations.

As shown in FIG. 3, logic flow 300 includes a block 302, in which an event object is created at a user device. This user device may include apparatus 100 of FIG. 1A or apparatus 150 of FIG. 1B. Thus, block 302 may be implemented with event object generation module 312. The embodiments, however, are not limited to the examples of FIGS. 1A and 1B.

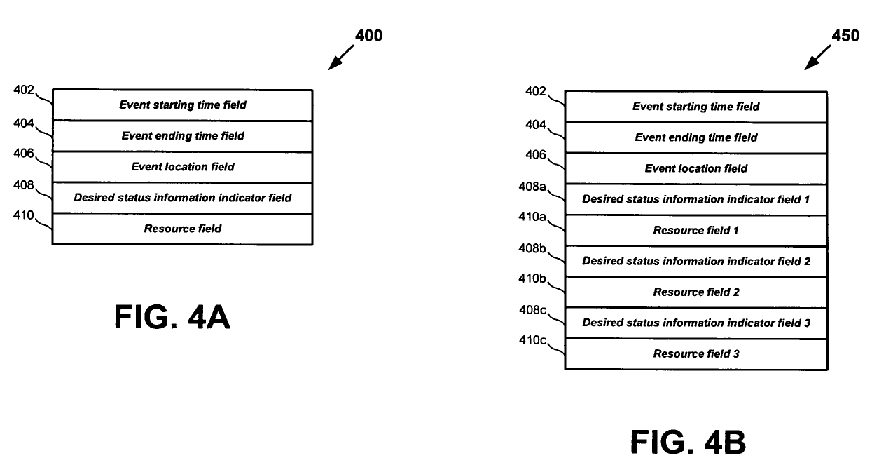

The event object, which corresponds to a future event, may include various forms of information. For instance, the created event object may include an indicator of desired status information associated with the event. The event object may also include a resource (e.g., a remote device such as resource server 204) that can provide the desired status information. Further, the event object may include an event time (e.g., a starting time, ending time, and/or duration), an event location, and so forth. Accordingly, the event object may be implemented, as described below with reference to FIGS. 4A and 4B. However, other event object implementations may be employed. Further, the event object may be included in a calendar entry.

In embodiments, creation of the event object may be initiated by a user (e.g., through user interface 104). Alternatively, creation of the event object may be initiated through the reception of a proposed event object from a remote device. Such a proposed event object may be included in a calendar entry sent by the remote device. Creation of the event object at the user device may occur upon the user accepting the calendar entry (e.g., through interaction with a user interface).

After being created, the event object may be stored by the user device. Referring again to FIGS. 1A and 1B, the event object may be stored in event object database 11 6. However, other storage arrangements may be employed.

As indicated by a block 303, the event object may be sent (or “uploaded”) to a remote monitoring device at a block 304. With reference to FIGS. 1A and 1B, this uploading may be performed by event status monitoring module 114. Upon receipt, the remote device may perform monitoring operations at a block 305. In the context of FIG. 2, this remote device may be monitoring server 206. However, other remote devices may be employed. These monitoring operations may involve sending one or more request messages to a resource indicated by the event object and receiving one or more response messages from the resource.

Alternatively or additionally, the user device may send one or more request messages for the desired status information at a block 306. Such request message(s) may be sent to a resource indicated in the event object. Referring to FIG. 2, this may involve sending request message(s) to resource server 204.

Blocks 305 and 306 may involve sending request message(s) according to various timing parameters. For instance, such request message(s) may be sent by the monitoring device and/or the user device once the corresponding event (e.g., its starting time) is scheduled to occur within a predetermined time interval. Also, such request message(s) may be sent repeatedly (e.g., periodically). This feature allows for the desired status information to be updated as the event approaches.

As shown in FIG. 3, the user device receives the desired status information at a block 308. This information may be received from a device that maintains the desired information. For example, referring again to FIG. 2, the device may be resource server 204. Alternatively, this information may be received from a device that monitors a further device, such as monitoring server 206. The embodiments, however, are not limited to the context of FIG. 2.

As described herein, the received information may provide interesting details regarding the event, its context, and/or its circumstances. Thus, at a block 310, the user may be notified of the received status information. In the context of FIGS. 1A and 1B such notifications may involve outputting a message to a display of user interface 104.

The nature of the received status information may indicate changes (actual or potential) in the corresponding event and/or conditions that may affect the user's participation in the event.

For example, the status information may indicate inclement weather that could cause a cancellation of the event. Also, the status information may indicate heavy traffic on the user's route to the event. This information may influence the user's behavior. For instance, the user may decide to depart for the event at an earlier time and/or take a different route to the event. Alternatively, this information may influence the user to forego attending the event altogether.

Accordingly, based on the notification provided at block 310, a corresponding calendar entry may be modified at a block 312. This may include, for example, changing the entry's time. Alternatively, this may include deleting the calendar entry. The corresponding calendar entry may have one or more participants at remote user devices. Thus, if the calendar entry is modified, the user device may send the modified calendar entry to the other participant(s) at a block 314.

In embodiments, blocks 312 and 314 may be performed automatically with some (or no) user interaction. Alternatively, blocks 312 and 314 may be performed manually through user input.

FIG. 4A is a diagram showing a format of an exemplary event object 400 that corresponds to an event. Event object 400 may include various data fields. For instance, FIG. 4A shows event object 400 including an event starting time field 402, an event ending time field 404, an event location field 406, a desired status information indicator field 408, and a resource field 410. The embodiments, however, are not limited to these fields.

Event starting time field 402 and event ending time field 404 indicate when the corresponding event is scheduled to begin and end. As an alternative, event ending time field may be replaced (or supplemented) with an event duration field that indicates the corresponding event's duration.

Event location field 406 indicates the location of the corresponding event. As described above, location field 406 may be for example, an address, global positioning system (GPS) coordinates, an airport code, and so forth.

Desired status information indicator field 408 specifies desired information regarding the corresponding event. This field may contain one or more keywords and/or descriptors that are recognizable by monitoring entities. Thus, based on these keywords and/or descriptors, these monitoring entities may generate appropriate requests for the desired information. With reference to FIGS. 1A, 1B, and 2, such monitoring entities may include event status monitoring module 114 and/or monitoring server 206. The embodiments, however, are not limited to these examples.

Resource field 410 indicates a resource, such as a server, that may provide the desired status information indicated by field 408. As described above, this resource indicator may be in the form of a uniform resource locator (URL). However, other forms or types of resource indicators may be employed.

FIG. 4B is a diagram showing an exemplary event object 450, which is similar to the event object of FIG. 4A. However, event object 450 includes multiple pairings of desired status information fields 408 and resource fields 410. In particular, event object 450 includes status information indicator fields 408a-c, which correspond to resource fields 410a-c, respectively. Thus, in embodiments, multiple types of event-related information may be obtained through a single event object. For example, a single event object may include status information indicator and resource fields pertaining to weather conditions, as well as status information indicator and resource fields pertaining to traffic reports. Such status information indicator and resource fields may pertain to other types of information, as well.

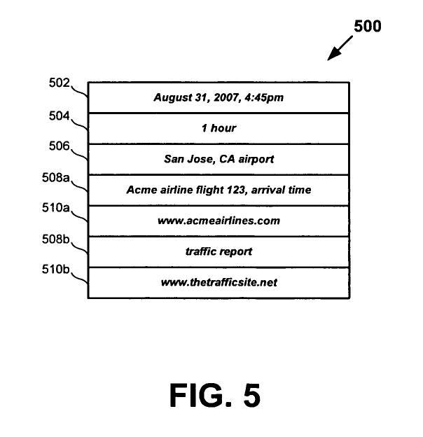

FIG. 5 is a diagram showing a further example of an event object. In particular, FIG. 5 is an event object 500 related to a flight arrival event. As shown in FIG. 5, event object 500 includes an event starting time field 502 that indicates 4:45 pm on Aug. 31, 2007, an event duration field 504 indicating one hour, and an event location field 506 indicating the San Jose, Calif. airport.

Further, event object 500 includes two status information indicator and resource field pairings. These include a desired status information indicator field 508a and a resource field 510a. As shown in FIG. 5, field 508a includes the descriptors (separated by a comma) “Acme airline flight 123” and “arrival time”. Further, FIG. 5 shows that resource field 510a indicates “www.acmeairlines.com”. Thus, from fields 508a, 510a, (and potentially one or more of fields 502-506) a monitoring entity may determine (from www.acmeairlines.com) whether Acme airlines flight 123 is on-time or delayed.

Event object 500 further includes a desired status information indicator field 508b including the descriptor “traffic report” and a resource field 508b indicating “www.thetrafficsite.net”. From these fields (as well as potentially one or more of fields 502-506 and other information (e.g., a user's devices current location)), a monitoring entity may obtain a traffic report for the user's route to the San Jose airport as the event's scheduled time approaches.

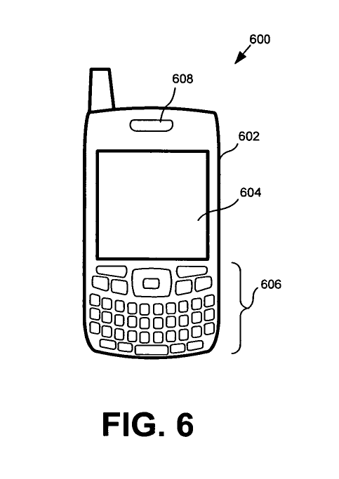

FIG. 6 provides a view of an exemplary handheld device 600, which may include apparatus 100 and 150 of FIGS. 1A and 1B. In particular, FIG. 6 is a front view that shows device 600 having a case 602. Further, this view shows device 600 having a display (e.g., a touch screen) 604, a keypad 606 (including, for example, a QWERTY keyboard, navigation buttons, and so forth), and a speaker 608. With reference to FIGS. 1A and 1B, these components may be included in user interface 104. The view of FIG. 6 is provided for the purposes of illustration, and not limitation. Thus, embodiments may include further devices, handheld or otherwise.

As described above, embodiments may include storage media, such as storage medium 108, storage medium 210, and storage medium 216. Such storage media may be implemented in various ways. For example, such storage media may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of storage medium 106 may be included in other elements of apparatus 100. For instance, some or all of storage medium 106 may be included on a same integrated circuit or chip with elements of apparatus 100 (e.g., host processor 106). Alternatively, some portion or all of storage medium 106 may be disposed on an integrated circuit or other medium (e.g., a hard disk drive) that is external. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
an event management module to create an event object corresponding to an event, the event object comprising a desired status information indicator; and
a communications interface module to receive the desired status information from a remote device, wherein the desired status information is based on the desired status information indicator.

2. The apparatus of claim 1, further comprising a calendar application module to create a calendar entry, wherein the event object is included in the calendar entry.

3. The apparatus of claim 2, wherein the calendar application module is to generate a user notification based on the received status information.

4. The apparatus of claim 3, wherein the calendar application module is to modify the calendar entry based on the notification.

5. The apparatus of claim 1:
wherein the event management module is to generate a request message, and the communications interface module is to send the request message to the remote device; and
wherein the received status information is received in response to the request message.

6. The apparatus of claim 5:
wherein the event object further comprises an event time; and
wherein the communications interface module is to send the request message within a predetermined time interval before the event time.

7. The apparatus of claim 1, wherein the communications interface module is to send the event object to the remote device, the remote device to obtain the desired status information from a further remote device.

8. The apparatus of claim 1, wherein the event object includes a location of the event.

9. The apparatus of claim 8, wherein the desired status information indicator specifies traffic conditions and/or weather data associated with the location.

10. The apparatus of claim 1, wherein the desired status information indicator specifies scheduling information of a transportation event.

11. The apparatus of claim 1, wherein the event object further comprises an indicator of a remote resource to provide the desired status information.

12. The apparatus of claim 1, wherein the desired status information is associated with the event.

13. A method, comprising:
creating an event object corresponding to an event, the event object comprising a desired status information indicator; and
receiving desired status information from a remote device, wherein the desired status information is based on the desired status information indicator.

14. The method of claim 13, further comprising:
notifying a local user based on the received status information.

15. The method of claim 14, further comprising:
modifying a calendar entry based on the user notification.

16. The method of claim 15,
wherein the calendar entry has one or more remote user participants;
wherein the method further comprises sending the modified calendar entry to the one or more remote user participants.

17. The method of claim 13, further comprising:
sending a request to the remote device for the desired status information.

18. The method of claim 13, further comprising:
sending the event object to the remote device, the remote device to obtain the desired status information from a further remote device.

19. A system, comprising:
a server; and
a user device having an event management module and a communications interface module;
wherein the event management module is to create an event object corresponding to an event, the event object comprising a desired status information indicator; and
wherein the communications interface module is to receive desired status information from the server, the desired status information based on the desired status information indicator.

20. An article comprising a computer-readable storage medium containing instructions that if executed enable a system to:
create an event object corresponding to an event, the event object comprising a desired status information indicator; and
receive the desired status information from a remote device, wherein desired status information is based on the desired status information indicator.
